(19) United States
(12) Patent Application Publication
(10) Pub. No.: US 2019/0276029 A1
(43) Pub. Date: Sep. 12, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Dan Umeda, Wako-shi (JP); Yugo Ueda, Wako-shi (JP); Akihiro Toda, Wako-shi (JP); Yuki Motegi, Tokyo (JP)

(21) Appl. No.: 16/292,463

(22) Filed: Mar. 5, 2019

(30) Foreign Application Priority Data
Mar. 7, 2018 (JP) 2018-041268

(51) Int. Cl. B60W 30/18; B60W 30/165; G08G 1/052; G06K 9/00

(52) U.S. Cl. CPC B60W 30/18163; B60W 30/165; G08G 1/052; B60W 2550/308; G06K 9/00818; B60W 2550/302; G06K 9/00825

(57) ABSTRACT

A vehicle control device includes a recognizer configured to recognize a situation in the vicinity of a host vehicle, a first determiner configured to determine whether or not speed of a preceding vehicle present in front of the host vehicle in a host vehicle lane where the host vehicle is present is less than prescribed speed, a second determiner configured to determine whether or not a following vehicle present behind the host vehicle in the host vehicle lane has overtaken the host vehicle when the first determiner determines that the speed of the preceding vehicle is less than the prescribed speed, and a driving controller configured to control speed and steering of the host vehicle and cause the host vehicle to overtake the preceding vehicle when the second determiner determines that the following vehicle has overtaken the host vehicle.

### CROSS-REFERENCE TO RELATED APPLICATION

Priority is claimed on Japanese Patent Application No. 2018-041268, filed Mar. 7, 2018, the content of which is incorporated herein by reference.

### BACKGROUND

### Field of the Invention

The present invention relates to a vehicle control device, a vehicle control method, and a storage medium.

### Description of Related Art

In recent years, research on automatically controlling driving of a vehicle (hereinafter referred to as automated driving) has been conducted. In relation thereto, technology for setting a stop position at which a host vehicle stops in front of a front stopped vehicle when the stopped vehicle is detected in front of the host vehicle and another vehicle entering an oncoming lane adjacent to the host vehicle lane is detected is known (For example, Japanese Unexamined Patent Application, First Publication No. 2015-64747).

### SUMMARY

In the conventional technology, it may not be possible to distinguish whether the stopped vehicle is a vehicle parked or stopped on a road or a vehicle stopped due to a traffic jam such as a signal. When the vehicle is automatically driven under such circumstances, it is assumed that it is not possible to determine whether or not it is necessary to appropriately overtake the stopped vehicle.

Aspects of the present invention have been made in consideration of such circumstances and an objective of the present invention is to provide a vehicle control device, a vehicle control method, and a storage medium that can more appropriately overtake a preceding vehicle in accordance with a surrounding traffic situation.

A vehicle control device, a vehicle control method, and a storage medium according to the present invention adopt the following configurations.

(1): According to an aspect of the present invention, there is provided a vehicle control device including: a recognizer configured to recognize a situation in the vicinity of a host vehicle; a first determiner configured to determine whether or not speed of a preceding vehicle present in front of the host vehicle in a host vehicle lane where the host vehicle is present is less than prescribed speed, the preceding vehicle being recognized by the recognizer; a second determiner configured to determine whether or not a following vehicle present behind the host vehicle in the host vehicle lane has overtaken the host vehicle when the first determiner determines that the speed of the preceding vehicle is less than the prescribed speed, the following vehicle being recognized by the recognizer; and a driving controller configured to control speed and steering of the host vehicle and cause the host vehicle to overtake the preceding vehicle when the second determiner determines that the following vehicle has overtaken the host vehicle.

(2): In the above-described aspect (1), the driving controller causes the host vehicle to overtake the preceding vehicle by causing the host vehicle to make a lane change to an adjacent lane adjacent to the host vehicle lane and the driving controller causes the host vehicle to follow the following vehicle by further controlling at least speed of the host vehicle when the host vehicle is made to make a lane change to the adjacent lane.

(3): In the above-described aspect (1), the second determiner determines whether or not a plurality of following vehicles have made a lane change to an adjacent lane adjacent to the host vehicle lane to overtake the host vehicle when the recognizer has recognized the plurality of following vehicles, and the driving controller controls speed and steering of the host vehicle to cause the host vehicle to overtake the preceding vehicle when the second determiner determines that the plurality of following vehicles have overtaken the host vehicle.

(4): In the above-described aspect (3), the driving controller causes the host vehicle to wait in the host vehicle lane until the second determiner determines that the plurality of following vehicles have overtaken the host vehicle.

(5): In the above-described aspect (1), the second determiner further determines whether or not there is a road sign indicating the prohibition of parking or stopping alongside the host vehicle lane, and the driving controller prevents the host vehicle from overtaking the preceding vehicle when the second determiner determines that the road sign is present alongside the host vehicle lane.

(6): In the above-described aspect (1), the second determiner further determines whether or not there is a prescribed point at which overtaking within a prescribed distance in front of the host vehicle is prohibited, and the driving controller prevents the host vehicle from overtaking the preceding vehicle when the second determiner determines that the prescribed point is present within the prescribed distance in front of the host vehicle.

(7): In the above-described aspect (1), the recognizer recognizes a light color of a traffic light in front of the host vehicle, the second determiner further determines whether or not the light color of the traffic light recognized by the recognizer is a prescribed color indicating passage prohibition, and the driving controller prevents the host vehicle from overtaking the preceding vehicle when the second determiner determines that the light color of the traffic light is the prescribed color.

(8): In the above-described aspect (1), the second determiner further determines whether or not the preceding vehicle is a prescribed type of vehicle, and, when the second determiner determines that the preceding vehicle is the prescribed type of vehicle, the driving controller controls speed and steering of the host vehicle and causes the host vehicle to overtake the preceding vehicle.

(9): In the above-described aspect (1), the first determiner further determines whether or not speed of the following vehicle overtaking the host vehicle in an adjacent lane adjacent to the host vehicle lane is less than prescribed speed, and, when the second determiner determines that the following vehicle has overtaken the host vehicle and the first determiner determines that the speed of the following vehicle overtaking the host vehicle in the adjacent lane adjacent to the host vehicle lane is less than or equal to the prescribed speed, the driving controller prevents the host vehicle from overtaking the preceding vehicle.

(10): In the above-described aspect (1), when the recognizer does not recognize the following vehicle until a prescribed time has elapsed after the first determiner determines that the speed of the preceding vehicle is less than the prescribed speed or when the second determiner does not determine that the following vehicle has overtaken the host vehicle, the driving controller controls speed and steering of the host vehicle and causes the host vehicle to overtake the preceding vehicle.

(11): According to another aspect of the present invention, there is provided a vehicle control method including: recognizing, by an in-vehicle computer, a situation in the vicinity of a host vehicle; determining, by the in-vehicle computer, whether or not speed of a preceding vehicle present in front of the host vehicle in a host vehicle lane where the host vehicle is present is less than prescribed speed, the preceding vehicle being a recognized vehicle; determining, by the in-vehicle computer, whether or not a following vehicle present behind the host vehicle in the host vehicle lane has overtaken the host vehicle when it is determined that the speed of the preceding vehicle is less than the prescribed speed, the following vehicle being a recognized vehicle; and controlling, by the in-vehicle computer, speed and steering of the host vehicle and causing the host vehicle to overtake the preceding vehicle when it is determined that the following vehicle has overtaken the host vehicle.

(12): According to another aspect of the present invention, there is provided a computer-readable non-transitory storage medium storing a program for causing an in-vehicle computer to execute: a process of recognizing a situation in the vicinity of a host vehicle; a process of determining whether or not speed of a preceding vehicle present in front of the host vehicle in a host vehicle lane where the host vehicle is present is less than prescribed speed, the preceding vehicle being a recognized vehicle; a process of determining whether or not a following vehicle present behind the host vehicle in the host vehicle lane has overtaken the host vehicle when it is determined that the speed of the preceding vehicle is less than the prescribed speed, the following vehicle being a recognized vehicle; and a process of controlling speed and steering of the host vehicle and causing the host vehicle to overtake the preceding vehicle when it is determined that the following vehicle has overtaken the host vehicle.

According to the above-described aspects (1) to (12), it is possible to more appropriately overtake a preceding vehicle in accordance with a surrounding traffic situation.

### BRIEF DESCRIPTION OF THE DRAWINGS

FIG. 1 is a configuration diagram of a vehicle system using a vehicle control device according to a first embodiment.

FIG. 2 is a functional configuration diagram of a first controller and a second controller.

FIG. 3 is a flowchart showing an example of a flow of a series of processes of the automated driving control device of the first embodiment.

FIG. 4 is a diagram showing an example of a scene in which a preceding vehicle is overtaken.

FIG. 5 is a diagram showing an example of a scene in which a preceding vehicle is overtaken.

FIG. 6 is a diagram showing an example of a scene in which a preceding vehicle is overtaken.

FIG. 7 is a diagram showing an example of a scene in which a preceding vehicle is not overtaken.

FIG. 8 is a diagram showing an example of a scene in which a preceding vehicle is not overtaken.

FIG. 9 is a diagram showing another example of a scene in which a preceding vehicle is not overtaken.

FIG. 10 is a diagram showing another example of a scene in which a preceding vehicle is not overtaken.

FIG. 11 is a diagram showing another example of a scene in which a preceding vehicle is not overtaken.

FIG. 12 is a diagram showing another example of a scene in which a preceding vehicle is not overtaken.

FIG. 13 is a diagram showing another example of a scene in which a preceding vehicle is overtaken.

FIG. 14 is a diagram showing an example of a scene in which there are a plurality of following vehicles.

FIG. 15 is a diagram showing an example of a scene in which there are a plurality of following vehicles.

FIG. 16 is a diagram showing an example of a scene in which there are a plurality of following vehicles.

FIG. 17 is a diagram showing an example of a hardware configuration of an automated operation control device of an embodiment.

### DESCRIPTION OF EMBODIMENTS

Embodiments of a vehicle control device, a vehicle control method, and a storage medium of the present invention will be described below with reference to the drawings. Although a case in which left-hand traffic regulations are applied will be described, it is only necessary to reverse the left and right when right-hand traffic regulations are applied.

### First Embodiment

### [Overall Configuration]

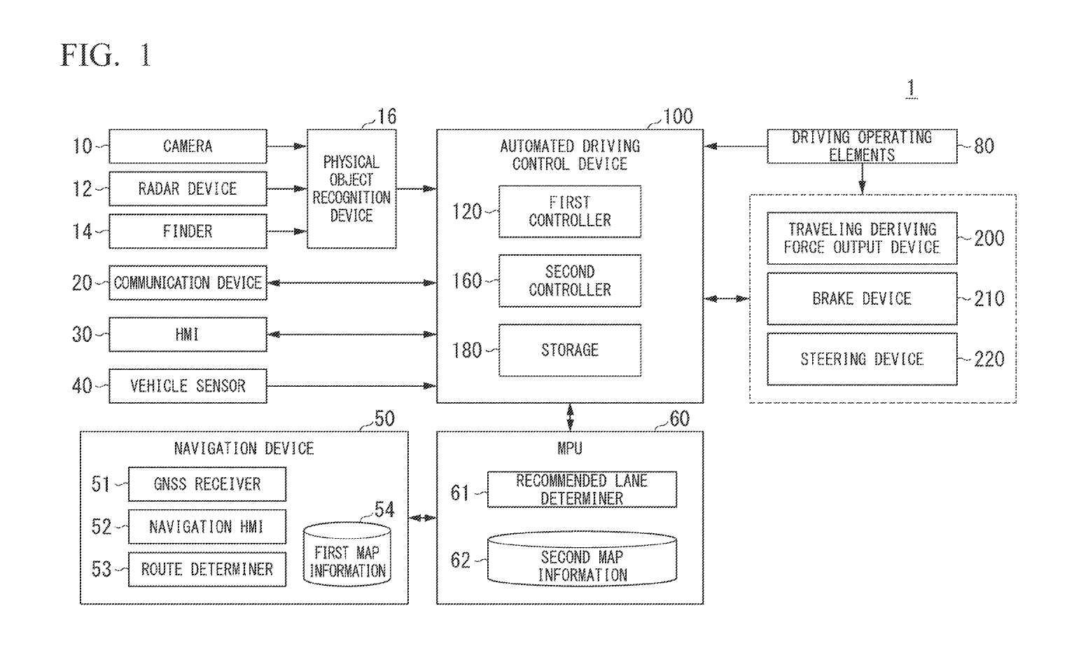

FIG. 1 is a configuration diagram of a vehicle system 1 using a vehicle control device according to a first embodiment. A vehicle equipped with the vehicle system 1 (hereinafter referred to as a “host vehicle M”) is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a power generator connected to the internal combustion engine, or discharge power of a secondary battery or a fuel cell.

The vehicle system 1 includes, for example, a camera 10, a radar device 12, a finder 14, a physical object recognition device 16, a communication device 20, a human machine interface (HMI) 30, a vehicle sensor 40, a navigation device 50, a map positioning unit (MPU) 60, driving operating elements 80, an automated driving control device 100, a traveling driving force output device 200, a brake device 210, and a steering device 220. These devices and apparatuses are connected to each other by a multiplex communication line such as a controller area network (CAN) communication line, a serial communication line, a wireless communication network, or the like. Also, the configuration shown in FIG. 1 is merely an example, and a part of the configuration may be omitted or another configuration may be further added.

For example, the camera 10 is a digital camera using a solid-state imaging device such as a charge coupled device (CCD) or a complementary metal oxide semiconductor (CMOS). The camera 10 is attached to any position of the host vehicle M. When a view in front is imaged, the camera 10 is attached to an upper portion of a front windshield, a rear surface of a rearview mirror, or the like. For example, the camera 10 periodically and iteratively images the vicinity of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any position on the host vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the host vehicle M and measures scattered light. The finder 14 detects a distance to an object on the basis of a time from light emission to light reception. The radiated light is, for example, pulsed laser light. The finder 14 is attached to any position of the host vehicle M.

The physical object recognition device 16 performs a sensor fusion process on detection results from some or all of the camera 10, the radar device 12, and the finder 14 to recognize a position, a type, speed, and the like of a physical object. The physical object recognition device 16 outputs recognition results to the automated driving control device 100. The physical object recognition device 16 may output detection results as they are from some or all of the camera 10, the radar device 12, and the finder 14 to the automated driving control device 100. The physical object recognition device 16 may be omitted from the vehicle system 1.

The communication device 20 communicates with another vehicle present in the vicinity of the host vehicle M using, for example, a cellular network, a Wi-Fi network, Bluetooth (registered trademark), dedicated short range communication (DSRC), or the like or communicates with various types of server devices via a wireless base station.

The HMI 30 presents various types of information to an occupant of the host vehicle M and receives an input operation of the occupant. The HMI 30 includes various types of display devices, a speaker, a buzzer, a touch panel, a switch, keys, and the like.

The vehicle sensor 40 includes a vehicle speed sensor configured to detect speed of the host vehicle M, an acceleration sensor configured to detect acceleration, a yaw rate sensor configured to detect angular speed around a vertical axis, a direction sensor configured to detect a direction of the host vehicle M, and the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory.

The GNSS receiver 51 identifies a position of the host vehicle M on the basis of a signal received from a GNSS satellite. The position of the host vehicle M may be identified or corrected by an inertial navigation system (INS) using an output of the vehicle sensor 40.

The navigation HMI 52 includes a display device, a speaker, a touch panel, keys, and the like. The navigation HMI 52 may be partly or wholly shared with the above-described HMI 30.

For example, the route determiner 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60.

The navigation device 50 may perform route guidance using the navigation HMI 52 on the basis of the route on the map. The navigation device 50 may be implemented, for example, according to a function of a terminal device such as a smartphone or a tablet terminal possessed by an occupant. The navigation device 50 may transmit a current position and a destination to a navigation server via the communication device 20 and acquire a route equivalent to the route on the map from the navigation server.

For example, the MPU 60 includes a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] with respect to a traveling direction of the vehicle), and determines a recommended lane for each block with reference to the second map information 62. The recommended lane determiner 61 determines what number lane the vehicle travels on from the left. The recommended lane determiner 61 determines the recommended lane so that the host vehicle M can travel along a reasonable traveling route for traveling to an interchange destination when there is an interchange in the route on the map.

The second map information 62 is map information which has higher accuracy than the first map information 54. For example, the second map information 62 includes information about a center of a lane, information about a boundary of a lane, information about a type of lane, or the like. The second map information 62 may include road information, traffic regulations information, address information (an address/zip code), facility information, telephone number information, and the like. The second map information 62 may be updated at any time when the communication device 20 communicates with another device.

For example, the driving operating element 80 includes an accelerator pedal, a brake pedal, a shift lever, a steering wheel, a steering wheel variant, a joystick, and other operating elements. A sensor configured to detect an amount of operation or the presence or absence of an operation is attached to the driving operating element 80, and a detection result thereof is output to the automated driving control device 100 or some or all of the traveling driving force output device 200, the brake device 210, and the steering device 220.

For example, the automated driving control device 100 includes a first controller 120, a second controller 160, and a storage 180. For example, the first controller 120 and the second controller 160 are implemented by a processor such as a central processing unit (CPU) executing a program (software). Some or all of these components are implemented, for example, by hardware (a circuit unit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in the storage 180 or stored in a removable storage medium such as a DVD or a CD-ROM, and installed in the storage 180 when the storage medium is mounted in a drive device.

The storage 180 is implemented by, for example, an HDD, a flash memory, an electrically erasable programmable read only memory (EEPROM), a read only memory (ROM), a random access memory (RAM), or the like. The storage 180 stores, for example, a program that is read and executed by the processor.

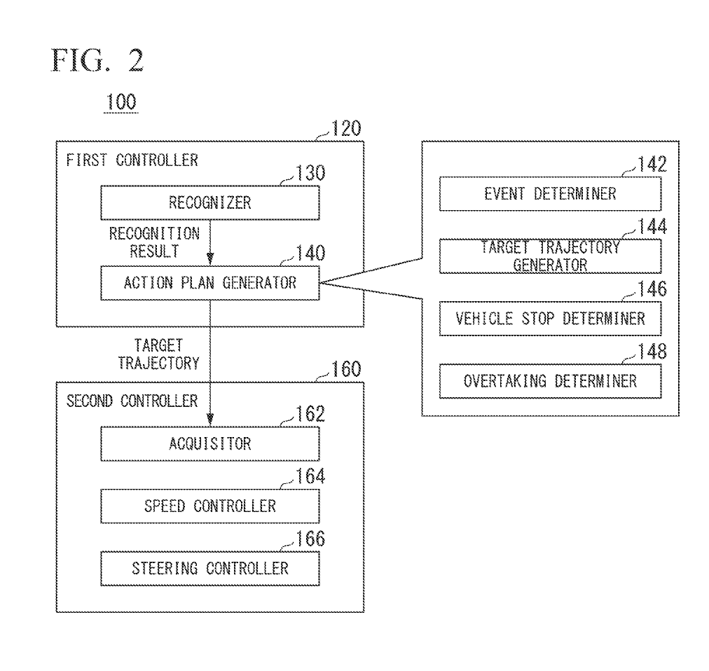

FIG. 2 is a functional configuration diagram of the first controller 120 and the second controller 160. The first controller 120 includes, for example, a recognizer 130 and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals capable of pattern matching, road signs, or the like) in parallel and performing comprehensive evaluation by assigning scores to both the recognitions. Thereby, the reliability of automated driving is secured.

The recognizer 130 recognizes states of a position, velocity, acceleration, and the like of a physical object present in the vicinity of the host vehicle M on the basis of information input from the camera 10, the radar device 12, and the finder 14 via the physical object recognition device 16. For example, the position of the physical object is recognized as a position on absolute coordinates (i.e., a relative position with respect to the host vehicle M) with a representative point (a center of gravity, a driving shaft center, or the like) of the host vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

For example, the recognizer 130 recognizes a lane (a traveling lane) in which the host vehicle M is traveling. For example, the recognizer 130 recognizes the traveling lane by comparing a pattern of a road dividing line (for example, an arrangement of solid lines and broken lines) obtained from the second map information 62 with a pattern of a road dividing line in the vicinity of the host vehicle M recognized from an image captured by the camera 10. The recognizer 130 may recognize a traveling lane by recognizing a traveling path boundary (a road boundary) including a road dividing line, a road shoulder, a curb stone, a median strip, a guardrail, or the like as well as a road dividing line. In this recognition, a position of the host vehicle M acquired from the navigation device 50 or a processing result of the INS may be added. The recognizer 130 recognizes a temporary stop line, an obstacle, red traffic light, a toll gate, and other road events.

When the traveling lane is recognized, the recognizer 130 recognizes a relative position or orientation of the host vehicle M with respect to the traveling lane. For example, the recognizer 130 may recognize a gap of a reference point of the host vehicle M from the center of the lane and an angle formed with respect to a line connecting the center of the lane in the traveling direction of the host vehicle M as a relative position and an orientation of the host vehicle M with respect to the traveling lane. Instead, the recognizer 130 may recognize a position of the reference point of the host vehicle M relative to one side end portion (a road dividing line or a road boundary) of the traveling lane as a relative position of the host vehicle M relative to the traveling lane.

The action plan generator 140 includes, for example, an event determiner 142, a target trajectory generator 144, a vehicle stop determiner 146, and an overtaking determiner 148. The vehicle stop determiner 146 is an example of a “first determiner” and the overtaking determiner 148 is an example of a “second determiner”.

The event determiner 142 determines an automated driving event in a route on which a recommended lane has been determined. The event is information defining a traveling mode of the host vehicle M.

The event includes, for example, a constant-speed traveling event for causing the host vehicle M to travel in the same lane at constant speed, a following traveling event for causing the host vehicle M to follow another vehicle (hereinafter referred to as a preceding vehicle) that is present within a prescribed distance (for example, from about several tens of [m] to about several hundreds of [m]) in front of the host vehicle M, a lane change event for causing the host vehicle M to make a lane change from the host vehicle lane to an adjacent lane, an interchange event for causing the host vehicle M to travel on a lane in a target direction at an interchange of a road, a junction event for causing the host vehicle M to join a main lane at a junction, a takeover event for ending automated driving and performing switching to manual driving, and the like. “Following” may be, for example, a traveling mode for causing a vehicular gap (a relative distance) between the host vehicle M and the preceding vehicle to be constantly maintained. “Following” may be a traveling mode for causing a relative distance (a vehicular gap) related to a vehicle width direction between a dividing line for dividing the host vehicle lane and the host vehicle M to be constantly maintained while causing the relative distance (the vehicular gap) between the host vehicle M and the preceding vehicle to be constantly maintained. For example, the event may include an overtaking event for causing the host vehicle M to make a lane change to an original lane again after causing the host vehicle M to temporarily make a lane change to an adjacent lane and overtaking a preceding vehicle in the adjacent lane, an avoidance event for causing the host vehicle M to perform at least one of braking and steering in order to avoid the approach to an obstacle, and the like.

The event determiner 142 may change an already determined event to another event or determine a new event in accordance with a situation in the vicinity of the host vehicle M recognized by the recognizer 130 when the host vehicle M is traveling.

The target trajectory generator 144 generates a future target trajectory for causing the host vehicle M to automatically travel in a traveling mode defined according to an event (independently of a driver's operation) because the host vehicle M generally travels in the recommended lane determined by the recommended lane determiner 61 and further copes with a situation in the vicinity of the host vehicle M when the host vehicle M travels in the recommended lane. The target trajectory includes, for example, a position element that determines a future position of the host vehicle M and a speed element that determines future speed of the host vehicle M and the like.

For example, the target trajectory generator 144 determines a plurality of points (trajectory points) at which the host vehicle M is required to sequentially arrive as position elements of the target trajectory. The trajectory point is a point where the host vehicle M is required to reach for each prescribed travel distance (for example, about several [m]). The prescribed traveling distance may be calculated, for example, according to a road distance when the host vehicle M travels along a route.

The target trajectory generator 144 determines target speed and target acceleration for each prescribed sampling time (for example, about several tenths of [sec]) as speed elements of the target trajectory. The trajectory point may be a position at which the host vehicle M is required to arrive at the sampling time for each prescribed sampling time. In this case, the target speed or the target acceleration is determined by a sampling time and an interval between the trajectory points. The target trajectory generator 144 outputs information indicating the generated target trajectory to the second controller 160.

The vehicle stop determiner 146 determines whether or not the speed of the preceding vehicle present in front of the host vehicle M in the host vehicle lane (for example, within a prescribed distance in front of the host vehicle M) among one or more physical objects recognized by the recognizer 130 is less than prescribed speed. The prescribed speed is, for example, speed at which the preceding vehicle can be regarded to stop or slow down at about 0 [km/h] or about several [km/h]. A vehicle having speed less than the prescribed speed will be referred to as a “stopped vehicle” in the following description.

When the vehicle stop determiner 146 determines that the speed of the preceding vehicle is less than the prescribed speed, i.e., when the preceding vehicle is a stopped vehicle, the overtaking determiner 148 determines whether or not the following vehicle among one or more physical objects recognized by the recognizer 130 has made a lane change to an adjacent lane adjacent to the host vehicle lane and has overtaken the host vehicle M to determine whether or not the host vehicle M has overtaken the stopped vehicle. For example, the following vehicle is another vehicle closest to the host vehicle M among one or more other vehicles present behind the host vehicle M (for example, within a prescribed distance in a rear direction) in the host vehicle lane.

When the overtaking determiner 148 determines that the following vehicle has overtaken the host vehicle M in the adjacent lane, the above-described event determiner 142 changes a planned event to the overtaking event for a section in which the current host vehicle M travels. In this case, the target trajectory generator 144 generates a target trajectory according to the overtaking event. When the overtaking determiner 148 determines that the following vehicle has not overtaken the host vehicle M in the adjacent lane, the event determiner 142 maintains the current event without changing the planned event to the overtaking event for the current section in which the host vehicle M travels. In this case, the target trajectory generator 144 generates a target trajectory according to the current event.

When it is determined that the following vehicle has overtaken the host vehicle M in the adjacent lane, the overtaking determiner 148 may further determine whether or not a time-to-collision (TTC) associated with another vehicle in the adjacent lane that is a lane of a lane change destination during overtaking is greater than or equal to a prescribed time. In this case, the event determiner 142 may change the planned event to the overtaking event with respect to a section in which the current host vehicle M travels when the overtaking determiner 148 determines that the following vehicle overtakes the host vehicle M in the adjacent lane and the TTC associated with the other vehicle in the adjacent lane is greater than or equal to the prescribed time.

The second controller 160 controls the traveling driving force output device 200, the brake device 210, and the steering device 220 so that the host vehicle M passes through the target trajectory generated by the target trajectory generator 144 at a scheduled time.

The second controller 160 includes, for example, an acquisitor 162, a speed controller 164, and a steering controller 166. The combination of the event determiner 142, the target trajectory generator 144, and the second controller 160 is an example of a “driving controller”.

The acquisitor 162 acquires information of a target trajectory (a trajectory point) generated by the target trajectory generator 144 and causes the acquired information to be stored in the memory of the storage 180.

The speed controller 164 controls one or both of the traveling driving force output device 200 and the brake device 210 on the basis of speed elements (for example, target speed, target acceleration, and the like) included in the target trajectory stored in the memory.

The steering controller 166 controls the steering device 220 in accordance with position elements (for example, a curvature representing a degree of curve of a target trajectory) included in the target trajectory stored in the memory.

For example, processes of the speed controller 164 and the steering controller 166 are implemented by a combination of feed-forward control and feedback control. As one example, the steering controller 166 combines and executes feed-forward control according to the curvature of the road in front of the host vehicle M and feedback control based on a gap from the target trajectory.

The traveling driving force output device 200 outputs a traveling driving force (a torque) for the vehicle to travel to driving wheels. For example, the traveling driving force output device 200 includes a combination of an internal combustion engine, an electric motor, a transmission, and the like, and a power electric controller (ECU) configured to control them. The power ECU controls the above-described configuration in accordance with information input from the second controller 160 or information input from the driving operating element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with information input from the second controller 160 or information input from the driving operating element 80 so that a brake torque corresponding to a braking operation is output to each wheel. The brake device 210 may include a mechanism for transferring the hydraulic pressure generated by the operation of the brake pedal included in the driving operating element 80 to the cylinder via the master cylinder as a backup. The brake device 210 is not limited to the above-described configuration and may be an electronically controlled hydraulic brake device that controls an actuator in accordance with information input from the second controller 160 and transfers the hydraulic pressure of the master cylinder to the cylinder.

For example, the steering device 220 includes a steering ECU and an electric motor. The electric motor, for example, changes a direction of the steering wheels by applying a force to a rack and pinion mechanism. The steering ECU drives the electric motor and causes the direction of the steering wheels to be changed in accordance with the information input from the second controller 160 or the information input from the driving operating element 80.

### [Processing Flow]

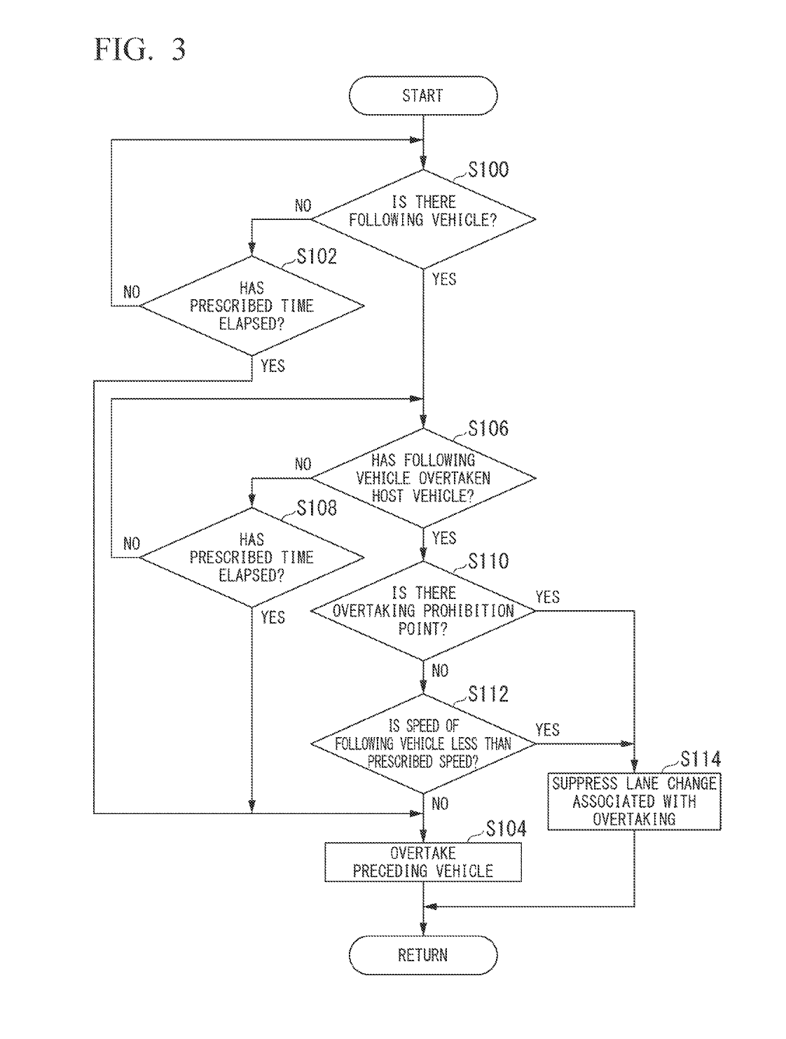

Hereinafter, a flow of a series of processes of the automated driving control device 100 of the first embodiment will be described with reference to a flowchart. FIG. 3 is a flowchart showing an example of the flow of a series of processes to be performed by the automated driving control device 100 of the first embodiment. For example, the vehicle stop determiner 146 performs the process of the present flowchart when it is determined that the preceding vehicle is present and the speed of the preceding vehicle is less than the prescribed speed, i.e., it is determined that the preceding vehicle is a stopped vehicle.

First, the overtaking determiner 148 determines whether or not there is a following vehicle on the basis of a recognition result of the recognizer 130 (step S100).

The overtaking determiner 148 further determines whether or not a prescribed time has elapsed after it is determined that the preceding vehicle is a stopped vehicle when it is determined that there is no following vehicle (step S102) and the process returns to S100 when it is determined that the prescribed time has not elapsed. At this time, the overtaking determiner 148 continues the counting of the elapsed time.

When there is no following vehicle and the prescribed time has not elapsed, the action plan generator 140 and the second controller 160 cause the host vehicle M to wait behind the preceding vehicle that is the stopped vehicle until the following vehicle has appeared or until the prescribed time has elapsed.

For example, when the host vehicle M waits behind the preceding vehicle that is the stopped vehicle, the event determiner 142 maintains the current event as it is if a current event is a following traveling event and changes the current event to the following traveling event if the current event is not the following traveling event. When the following traveling event has been planned under a situation in which the preceding vehicle is present, the target trajectory generator 144 generates a target trajectory in which target speed less than prescribed speed is included as a speed element so that a uniform vehicular gap between the host vehicle M and the preceding vehicle is maintained because the speed of the preceding vehicle is less than the prescribed speed. In response to this, the second controller 160 controls the speed and steering of the host vehicle M on the basis of the target trajectory, so that the host vehicle M continues to stop behind the preceding vehicle.

On the other hand, when it is determined that the prescribed time has elapsed in the determination processing of S102, the action plan generator 140 and the second controller 160 cause the host vehicle M to make a lane change to the adjacent lane and overtake the preceding vehicle (step S104). For example, the event determiner 142 changes an event planned in a current section to an overtaking event and the target trajectory generator 144 generates a target trajectory for overtaking the preceding vehicle on the basis of the overtaking event. In response to this, the second controller 160 causes the host vehicle M to temporarily make a lane change to the adjacent lane and causes the host vehicle M to make a lane change to an original lane again after overtaking the preceding vehicle in the adjacent lane by controlling the speed and the steering of the host vehicle M.

On the other hand, if it is determined that the following vehicle is present until the prescribed time has elapsed in the determination processing of S100, the overtaking determiner 148 determines whether or not the following vehicle has overtaken the host vehicle M (step S106). For example, the overtaking determiner 148 determines that the following vehicle has overtaken the host vehicle M when the recognizer 130 recognizes that the following vehicle has moved from a position behind the host vehicle M in the host vehicle lane to a position at which the following vehicle travels in parallel to the host vehicle M in the adjacent lane or a position in front of the host vehicle M.

The overtaking determiner 148 further determines whether or not a prescribed time has elapsed from the determination of the presence of the following vehicle when it is determined that the following vehicle is present (step S108) and returns the process to S106 if it is determined that the prescribed time has not elapsed. At this time, the overtaking determiner 148 continues the counting of the elapsed time.

When the following vehicle is present and the prescribed time has not elapsed, the action plan generator 140 and the second controller 160 cause the host vehicle M to wait behind a stopped vehicle until the following vehicle has overtaken the host vehicle M or until the prescribed time has elapsed.

On the other hand, when it is determined that the prescribed time has elapsed in the determination processing of S108, the action plan generator 140 and the second controller 160 move the process to S104 and cause the host vehicle M to make a lane change to the adjacent lane and overtake the preceding vehicle.

The overtaking determiner 148 further determines whether or not there is an overtaking prohibition point within a prescribed distance in front when viewed from the host vehicle M when it is determined that the following vehicle has overtaken the host vehicle M before the elapse of the prescribed time in the determination processing of S106 (step S110). The overtaking prohibition point includes, for example, an intersection, a railroad crossing, a crosswalk, a bicycle crossing zone, a corner of a road, a top of an uphill slope, a downhill slope of a threshold value or more, a tunnel, and the like. The prescribed distance is, for example, a distance of about 30 [m]. The overtaking prohibition point is an example of a “prescribed point”.

For example, the overtaking determiner 148 determines whether or not there is an overtaking prohibition point within a prescribed distance in front of the position of the host vehicle M identified by the navigation device 50 in a map represented by the first map information 54 or the second map information 62. For example, the overtaking determiner 148 may determine that there is an overtaking prohibition point in front when viewed from the host vehicle M when the recognizer 130 has recognized the overtaking prohibition point such as a pedestrian crossing, a bicycle crossing zone, or a tunnel or when the recognizer 130 has recognized a planimetric feature such as a traffic light, a sidewalk bridge, a breaker, a railroad track, an overhead line, or a temporary stop line, in front of the host vehicle M.

When the overtaking determiner 148 determines that there is no overtaking prohibited point within a prescribed distance in front as viewed from the host vehicle M, the vehicle stop determiner 146 determines whether or not the speed of the following vehicle overtaking the host vehicle M is less than prescribed speed (step S112).

When it is determined that the speed of the following vehicle is greater than or equal to the prescribed speed in the determination processing of S112, the action plan generator 140 and the second controller 160 move the process to S104 and cause the host vehicle M to make a lane change to the adjacent lane and overtake the preceding vehicle.

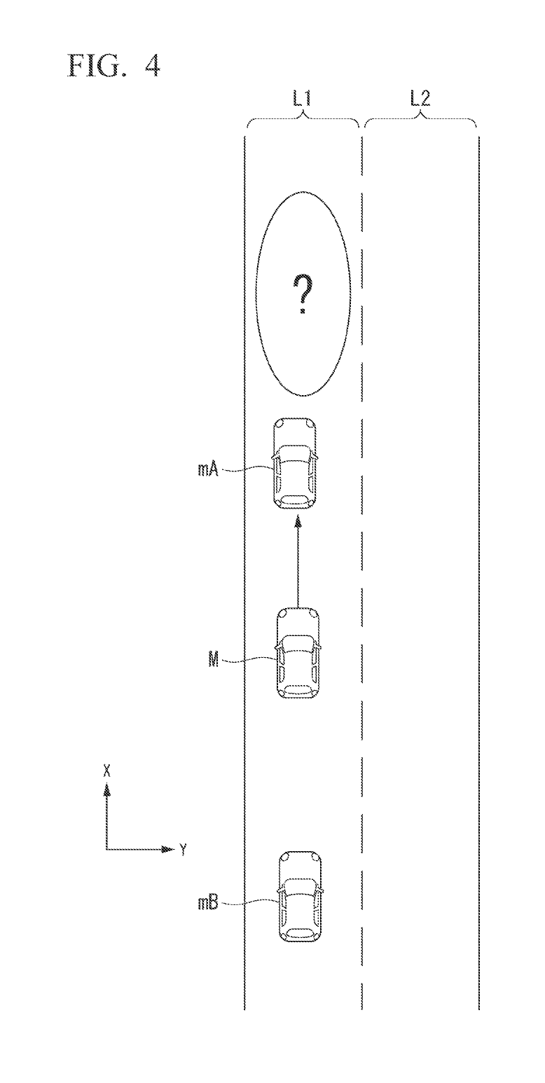

FIGS. 4 to 6 are diagrams showing an example of a scene in which a preceding vehicle is overtaken. In FIGS. 4 to 6, mA denotes a preceding vehicle, mB denotes a following vehicle, L1 denotes a host vehicle lane, and L2 denotes an adjacent lane. An X direction is a traveling direction of a vehicle and a Y direction is a vehicle width direction.

In the example of FIG. 4, a scene in which the speed of the preceding vehicle mA is less than the prescribed speed when the host vehicle M follows the preceding vehicle mA is shown. In this scene, the overtaking determiner 148 determines whether or not the following vehicle mB has made the lane change from the host vehicle lane L1 to the adjacent lane L2 and has overtaken the host vehicle M in the adjacent lane L2 before the elapse of the prescribed time.

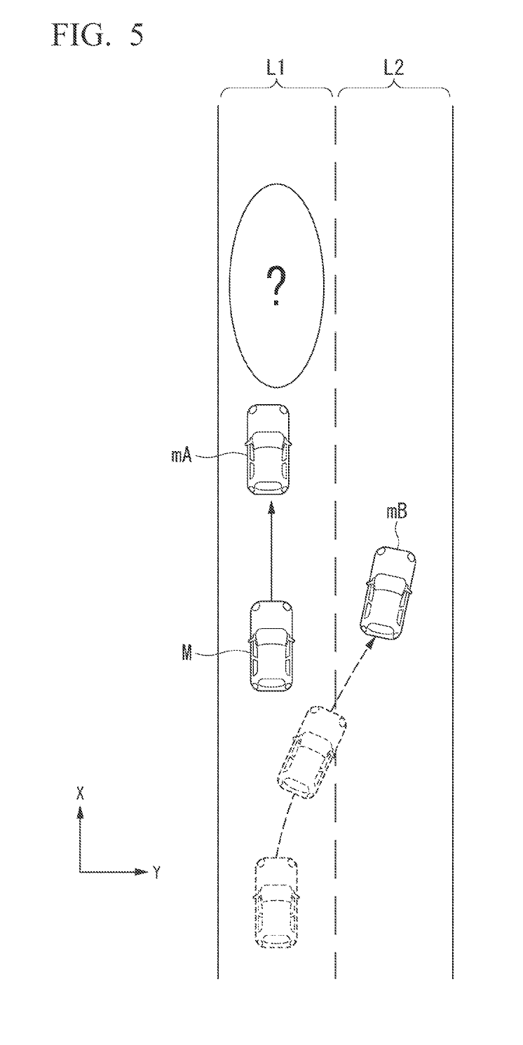

In the example of FIG. 5, a scene in which the following vehicle mB has overtaken the host vehicle M is shown. In the case of such a scene, because the overtaking determiner 148 determines that the following vehicle mB has overtaken the host vehicle M, the action plan generator 140 plans the overtaking event and generates a target trajectory based on the overtaking event. The second controller 160 controls the speed and steering of the host vehicle M in accordance with the target trajectory based on the overtaking event.

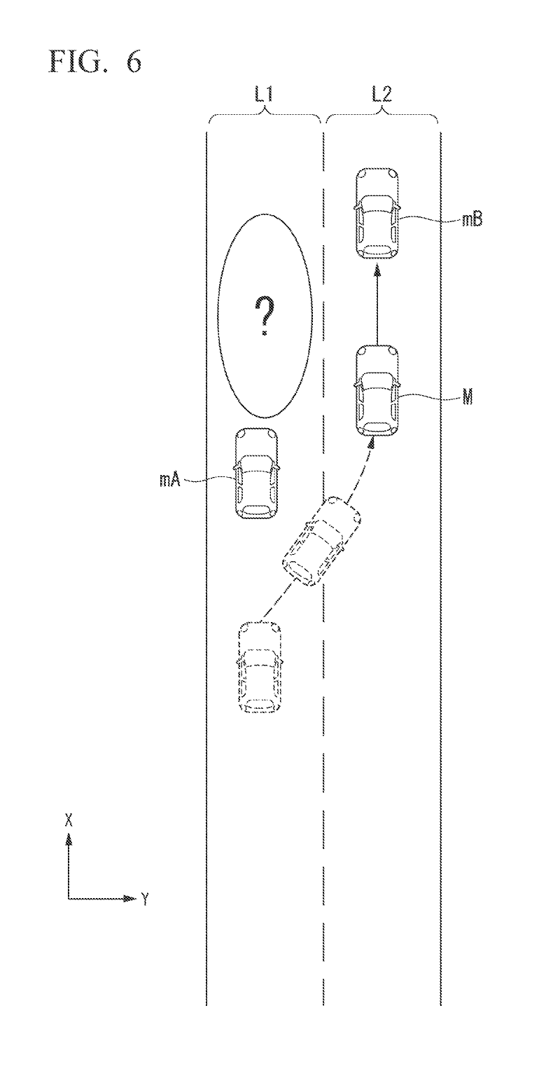

In the example of FIG. 6, a scene in which the host vehicle M has overtaken the preceding vehicle mA is shown. As shown, when the following vehicle mB has first overtaken the preceding vehicle mA including the host vehicle M, the following vehicle mB is present in front after the host vehicle M in the adjacent lane L2 makes a lane change. Thus, the action plan generator 140 may generate a target trajectory for causing the host vehicle M to follow the following vehicle mB in a process of overtaking the preceding vehicle mA in the adjacent lane L2. Thereby, it is possible to cause the host vehicle M to travel while tracing the movement of the following vehicle mB.

Generally, in a scene in which the preceding vehicle stops or slows down, there is a tendency that congestion occurs in front of the preceding vehicle mA or the preceding vehicle mA is merely parked or stopped on the road. Although the host vehicle M is required to overtake the preceding vehicle mA in accordance with a traveling situation of another vehicle that passes through the adjacent lane L2 when the preceding vehicle mA is a vehicle parked or stopped on the road, it may not determine whether or not the host vehicle M is required to overtake the preceding vehicle mA when congestion occurs in front of the preceding vehicle mA and it is not possible to recognize the number of vehicles present in front of the preceding vehicle mA with sufficient accuracy. Under a situation in which there is no confidence of whether or not overtaking is required, it is possible to more accurately determine whether or not the host vehicle M is required to overtake the preceding vehicle by adding the determination of the following vehicle mB as one determination index when there is a fact that the following vehicle mB has overtaken the host vehicle M.

On the other hand, when the action plan generator 140 and the second controller 160 suppress the lane change associated with overtaking when it is determined that there is an overtaking prohibition point within a prescribed distance in front when viewed from the host vehicle M in the determination processing of S110 or when it is determined that the speed of the following vehicle is less than prescribed speed in the determination processing of S112 (step S114). For example, the “suppression of the lane change” is the stopping of a part or all of control associated with the lane change.

For example, when there is an overtaking prohibition point or the speed of the following vehicle is less than the prescribed speed, the event determiner 142 maintains the current event as it is without changing the current event to the overtaking event or changes the current event to the following traveling event. Thereby, because the target trajectory generator 144 does not generate the target trajectory for overtaking the preceding vehicle, the second controller 160 stops the lane change of the host vehicle M to the adjacent lane. When the lane change to the adjacent lane is stopped, the second controller 160 may execute an operation of causing a direction indicator of the host vehicle M to be operated as a type of control associated with the lane change. That is, although the second controller 160 does not change the lane of the host vehicle M, the second controller 160 may cause a turn lamp of the adjacent lane side to be turned on and indicate an intention for changing the lane to nearby vehicles by operating the direction indicator. The direction indicator may include a switch (a lever) operated by an occupant, an electronic circuit for operating (turning on or blinking) the turn lamp by the switch, an indicator for indicating an operation state of the turn lamp to the occupant, and the like.

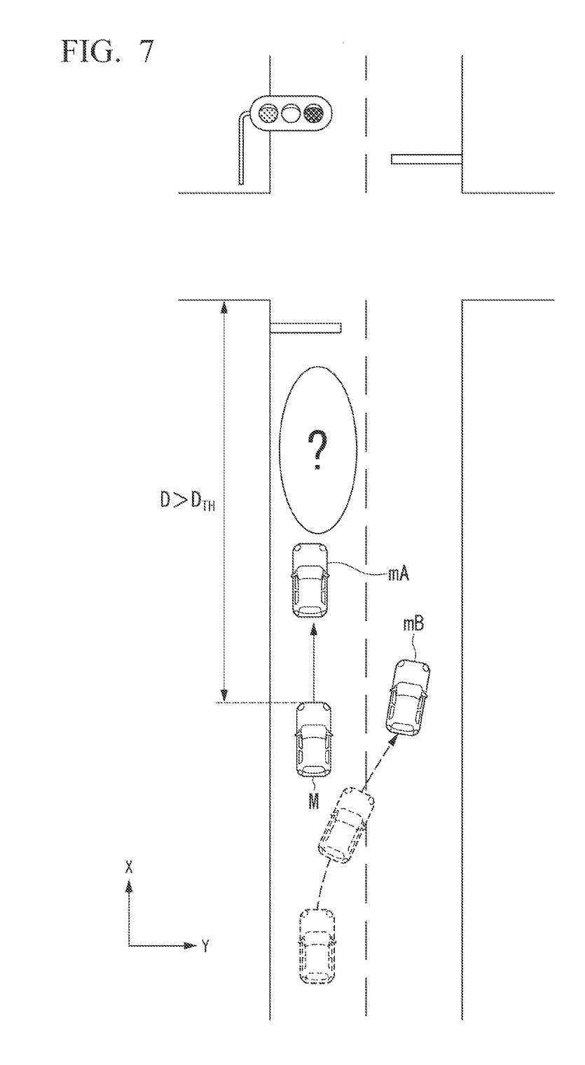

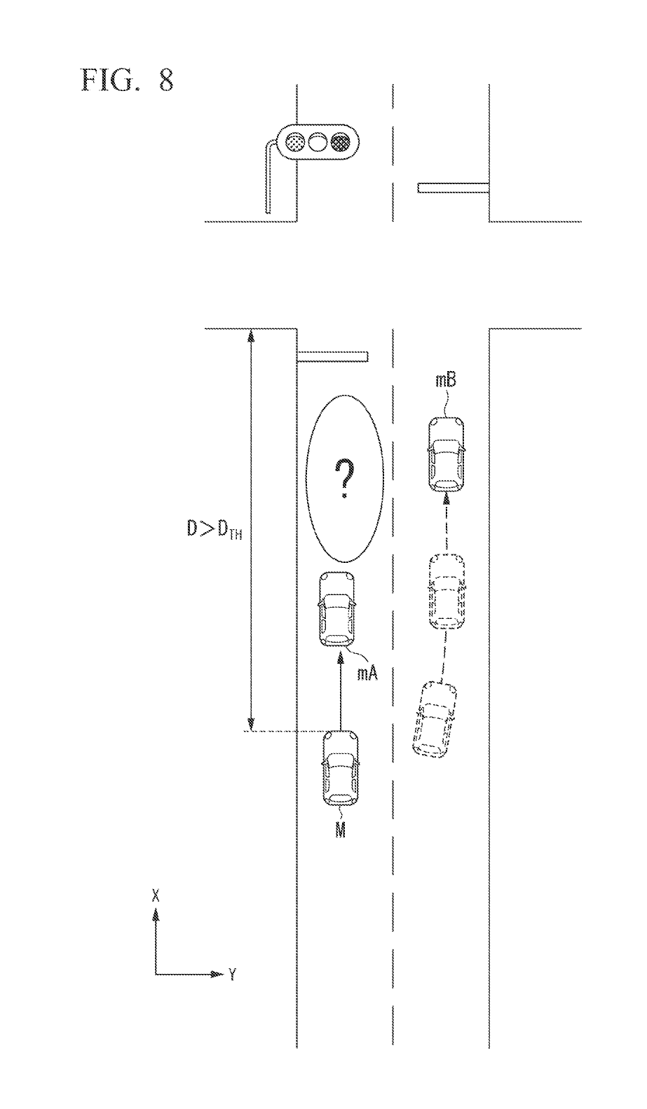

FIGS. 7 and 8 are diagrams showing an example of a scene in which a preceding vehicle is not overtaken. In the scene exemplified in FIG. 7, there is an intersection in front of the host vehicle M when viewed from the host vehicle M and a distance D between the intersection and the host vehicle M is shorter than a prescribed distance D_{TH}. In the scene exemplified in FIG. 7, the following vehicle mB makes a lane change to the adjacent lane L2 and overtakes the host vehicle M. In this case, the overtaking determiner 148 determines that the following vehicle mB has overtaken the host vehicle M and determines that there is an overtaking prohibition point within the prescribed distance D_{TH} in front of the host vehicle M when viewed from the host vehicle M (an intersection in the example of FIG. 7).

When such a determination result has been obtained, the action plan generator 140 and the second controller 160 do not cause the host vehicle M to make a lane change to the adjacent lane L2 by suppressing the lane change associated with the overtaking as in the scene exemplified in FIG. 8. When the lane change associated with overtaking is suppressed, the action plan generator 140 may generate a target trajectory for causing the host vehicle M to follow the preceding vehicle mA. As described above, because it is possible to determine that the preceding vehicle mA is likely to stop and slow down due to a traffic regulation of a traffic light or the like when the speed of the preceding vehicle mA is less than prescribed speed under a situation in which the overtaking prohibition point such as an intersection is present in front of the host vehicle M, the host vehicle M is made to follow the preceding vehicle mA in the host vehicle lane L1 and maintains the current speed until a color of the traffic light is changed and the preceding mA is accelerated (started) without causing the host vehicle M to make a lane change and overtake the preceding vehicle mA by imitating the overtaking even if the following vehicle mB has overtaken the host vehicle M.

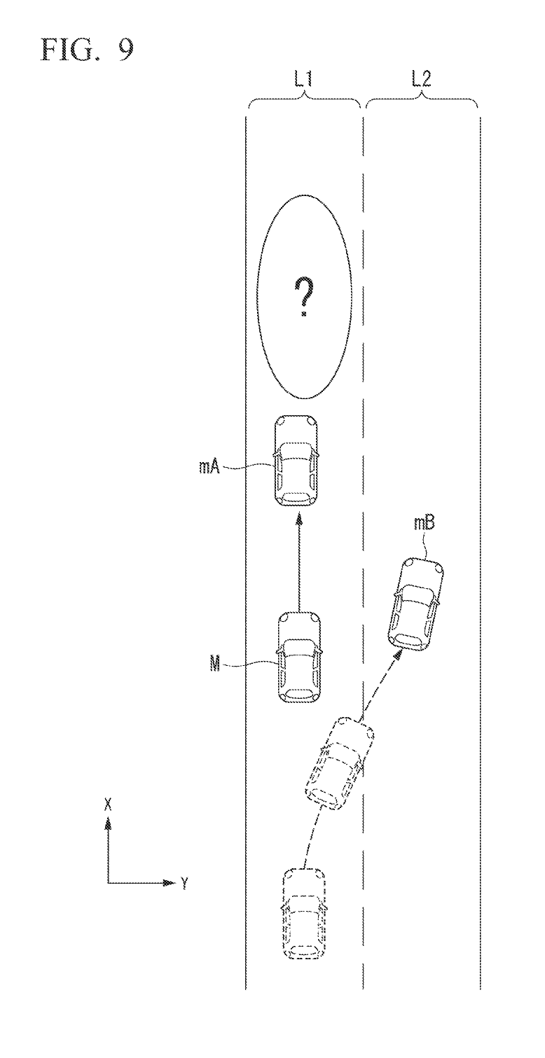

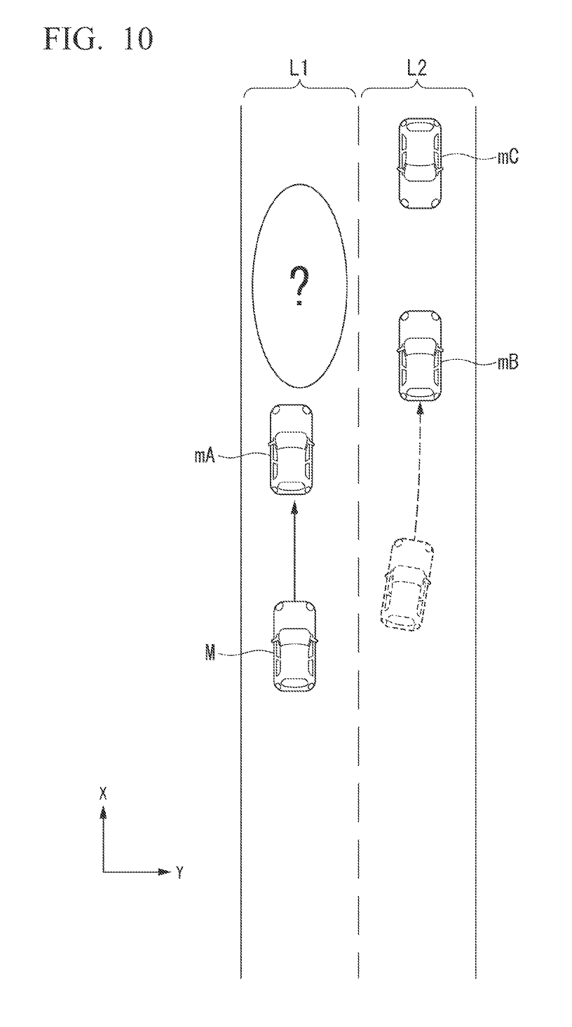

FIGS. 9 and 10 are diagrams showing another example of a scene in which a preceding vehicle is not overtaken. In the scene exemplified in FIG. 9, the following vehicle mB makes a lane change to the adjacent lane L2 and overtakes the host vehicle M. In this case, the overtaking determiner 148 determines that the following vehicle mB has overtaken the host vehicle M. At this time, for example, when the adjacent lane L2 is an oncoming lane having the traveling direction opposite to that of the host vehicle lane L1, an oncoming vehicle mC may approach in front of the following vehicle mB in the traveling direction as in the scene exemplified in FIG. 10. In this case, the following vehicle mB overtaking the host vehicle M is assumed to decelerate. When the following vehicle mB decelerates in the adjacent lane L2 and the speed of the following vehicle mB is less than prescribed speed, the action plan generator 140 and the second controller 160 suppress the lane change associated with overtaking. Thereby, it is possible to secure a space for the following vehicle mB to retreat in the adjacent lane L2.

In the process of the flowchart described above, in addition to or in place of the determination processing of S110 and S112, the overtaking determiner 148 may determine whether or not the light color of the traffic light is a prescribed color in front of the host vehicle M. The prescribed color is a color indicating that the traveling of the vehicle is prohibited, and is, for example, red. For example, when the traffic light is recognized in front of the host vehicle M by the recognizer 130 and the light color of the traffic light is further recognized thereby, the overtaking determiner 148 determines whether or not the recognized light color of the traffic light is a prescribed color. For example, when the communication device 20 communicates with a traffic light in front of the host vehicle M and a server that monitors an operation situation of the traffic light and the communication device 20 acquires information indicating the operation situation of the traffic light, the overtaking determiner 148 may determine whether or not the light color of the traffic light in front is a prescribed color on the basis of the information acquired by the communication device 20. When the overtaking determiner 148 determines that the light color of the traffic light is the prescribed color, the action plan generator 140 and the second controller 160 suppress the lane change associated with the overtaking.

The overtaking determiner 148 may determine whether or not there is a prescribed road sign alongside the host vehicle lane in addition to or in place of the determination processing of S110 and S112. The prescribed road sign includes, for example, a road sign of No Stopping. When the overtaking determiner 148 determines that there is a prescribed road sign alongside the host vehicle lane, the action plan generator 140 and the second controller 160 suppress the lane change associated with the overtaking.

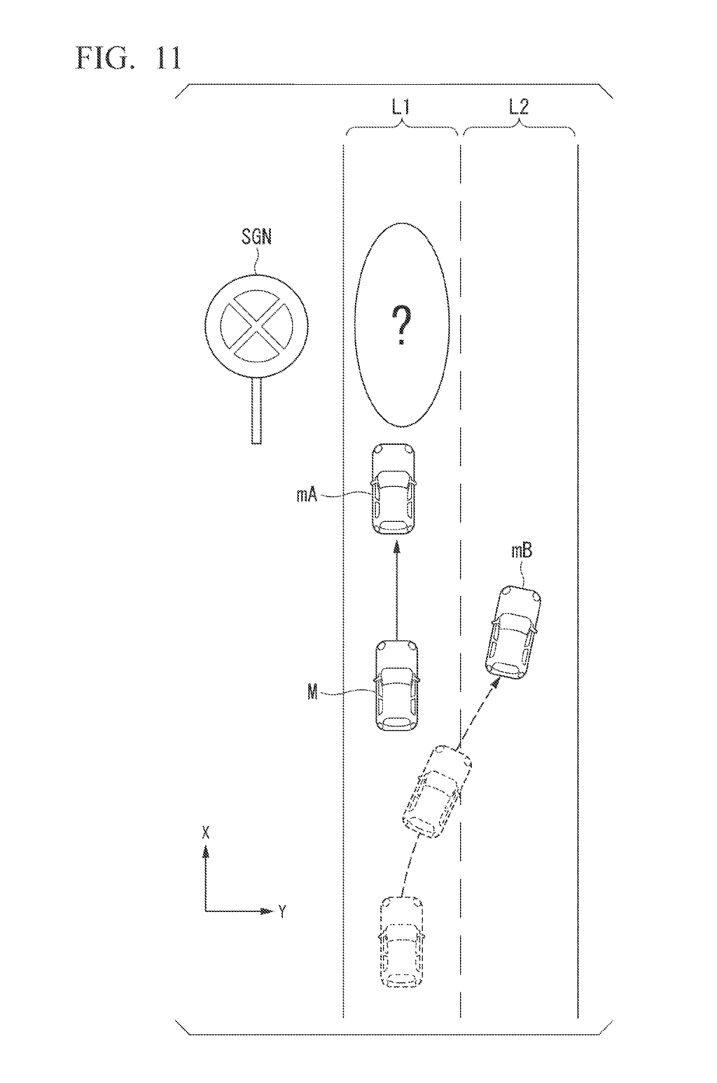

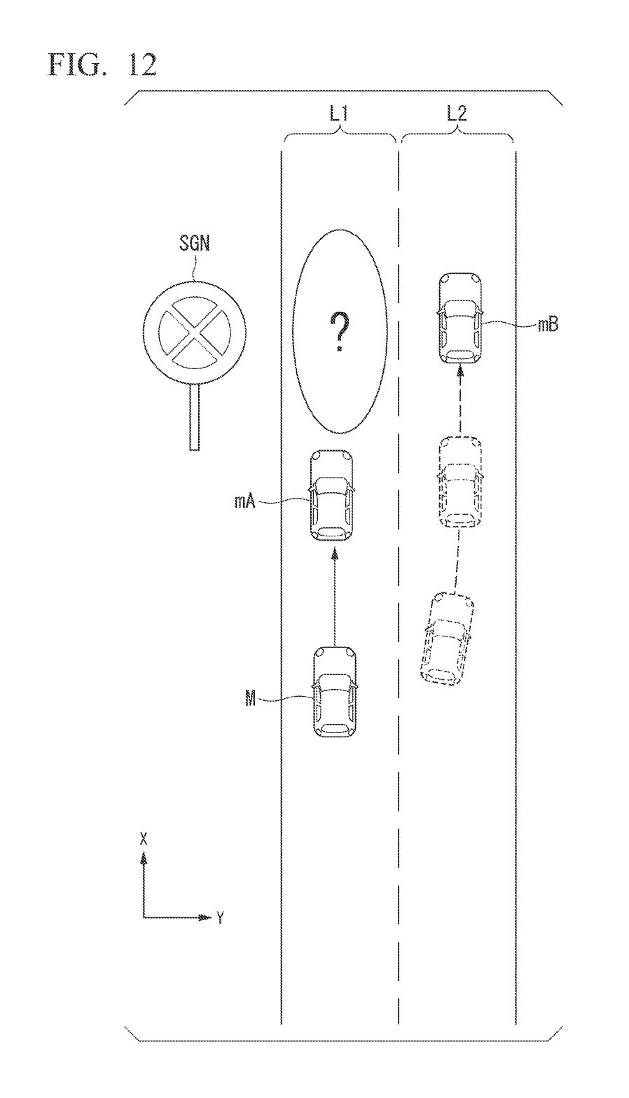

FIGS. 11 and 12 are diagrams showing another example of a scene in which a preceding vehicle is not overtaken. In the scene exemplified in FIG. 11, the following vehicle mB makes a lane change to the adjacent lane L2 and overtakes the host vehicle M. In the scene exemplified in FIG. 11, a rod sign SGN of No Stopping is installed along the left of the host vehicle lane L1. In this case, the overtaking determiner 148 determines that the following vehicle mB has overtaken the host vehicle M and determines that there is a prescribed road sign alongside the host vehicle lane L1. In this case, although the host vehicle M also originally overtakes the preceding vehicle mA subsequently to the following vehicle mB as in the case in which the following vehicle mB has performed overtaking if the preceding vehicle mA is a vehicle (a stopped vehicle) parked or stopped on the road, it is possible to determine that the preceding vehicle mA is not merely parked or stopped on the road, but is likely to be forced to stop by another factor because the preceding vehicle mA stops even though parking or stopping in the host vehicle lane L1 is prohibited. Thus, the action plan generator 140 and the second controller 160 suppress a lane change associated with overtaking as in the scene exemplified in FIG. 12. Thereby, even if the following vehicle mB has overtaken the host vehicle M, the host vehicle M can be made to follow the preceding vehicle mA in the host vehicle lane L1 and maintain current speed until an unstable event in which a vehicle is forced to stop even though parking or stopping on the road is prohibited is eliminated.

In the process of the flowchart described above, the overtaking determiner 148 may determine whether or not the preceding vehicle is a prescribed type of vehicle. The prescribed type of vehicle includes, for example, a vehicle such as a bus for carrying passengers and a vehicle for carrying baggage such as a truck. For example, when the recognizer 130 recognizes a vehicle width, a total length, and a vehicle height of the preceding vehicle, the overtaking determiner 148 determines that the preceding vehicle is a prescribed type of vehicle when sizes thereof are greater than or equal to a prescribed size. When the overtaking determiner 148 determines that the preceding vehicle is a prescribed type of vehicle, the action plan generator 140 and the second controller 160 cause the host vehicle M to make a lane change to the adjacent lane and overtake the preceding vehicle.

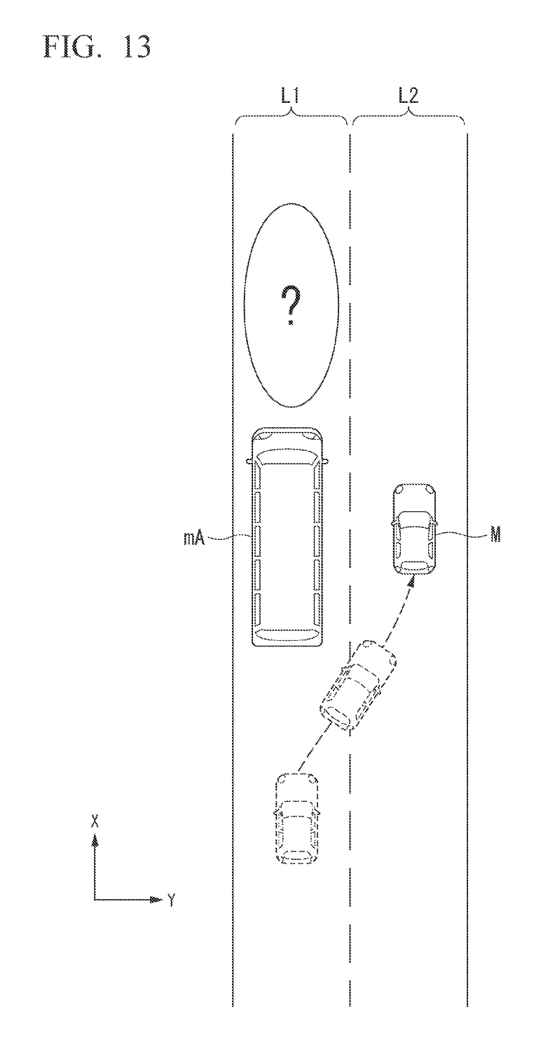

FIG. 13 is a diagram showing another example of a scene in which a preceding vehicle is overtaken. In the shown example, a preceding vehicle mA is recognized to be a bus. In this case, the overtaking determiner 148 determines that the preceding vehicle mA is a prescribed type of vehicle, the action plan generator 140 and the second controller 160 cause the host vehicle M to make a lane change to the adjacent lane L2 and overtake the preceding vehicle mA. As described above, when the preceding vehicle is stopped for boarding or deboarding of passengers and loading or unloading of baggage, the host vehicle M is made to overtake the preceding vehicle mA because the preceding vehicle mA is likely to continuously stop on the spot for a short time.

According to the first embodiment described above, because there are provided the recognizer 130 configured to recognize a physical object in the vicinity of the host vehicle M; the vehicle stop determiner 146 configured to determine whether or not speed of a preceding vehicle present in front of the host vehicle M in a host vehicle lane where the host vehicle M is present among one or more physical objects recognized by the recognizer 130 is less than prescribed speed; the overtaking determiner 148 configured to determine whether or not a following vehicle present behind the host vehicle M in the host vehicle lane among the one or more physical objects recognized by the recognizer 130 has overtaken the host vehicle M when the vehicle stop determiner 146 determines that the speed of the preceding vehicle is less than the prescribed speed; the target trajectory generator 144 configured to generate a target trajectory for overtaking the preceding vehicle when the overtaking determiner 148 determines that the following vehicle has overtaken the host vehicle M; and the second controller 160 configured to cause the host vehicle M to overtake the preceding vehicle by controlling speed and steering of the host vehicle M on the basis of the target trajectory generated by the target trajectory generator 144, it is possible to more accurately determine whether or not to cause the host vehicle M to follow the preceding vehicle overtaken by the following vehicle or whether or not to overtake the preceding vehicle. As a result, it is possible to more appropriately overtake a vehicle in front in accordance with a vicinity traffic situation.

### Second Embodiment

Hereinafter, a second embodiment will be described. The second embodiment is different from the above-described first embodiment in that there are a plurality of following vehicles behind a host vehicle M. In this case, for example, the following vehicles may be some or all vehicles of one or more other vehicles present behind the host vehicle M in a host vehicle lane. Hereinafter, differences from the first embodiment will be mainly described, and description of functions and the like in common with the first embodiment will be omitted.

In the second embodiment, an overtaking determiner 148 in the second embodiment determines whether or not a plurality of following vehicles have made a lane change to an adjacent lane adjacent to the host vehicle lane and have overtaken the host vehicle M when the plurality of following vehicles are recognized by the recognizer 130. An action plan generator 140 and a second controller 160 are configured to cause the host vehicle M to wait in the host vehicle lane without making the lane change to the adjacent lane until the overtaking determiner 148 determines that the plurality of following vehicles have overtaken the host vehicle M and to cause the host vehicle M to make a lane change to the adjacent lane and overtake the preceding vehicle when the overtaking determiner 148 determines that the plurality of following vehicles have overtaken the host vehicle M.

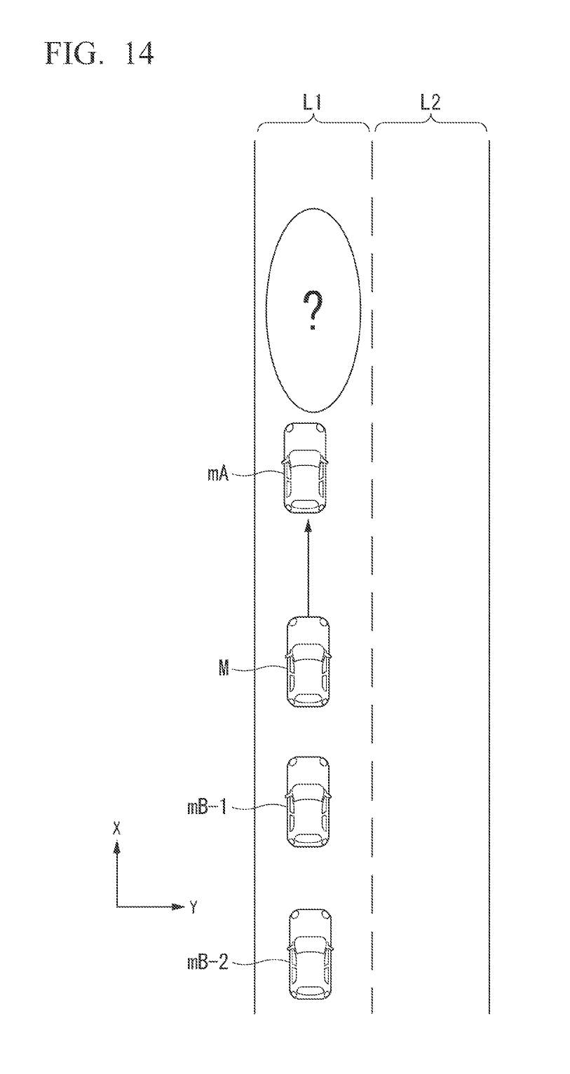

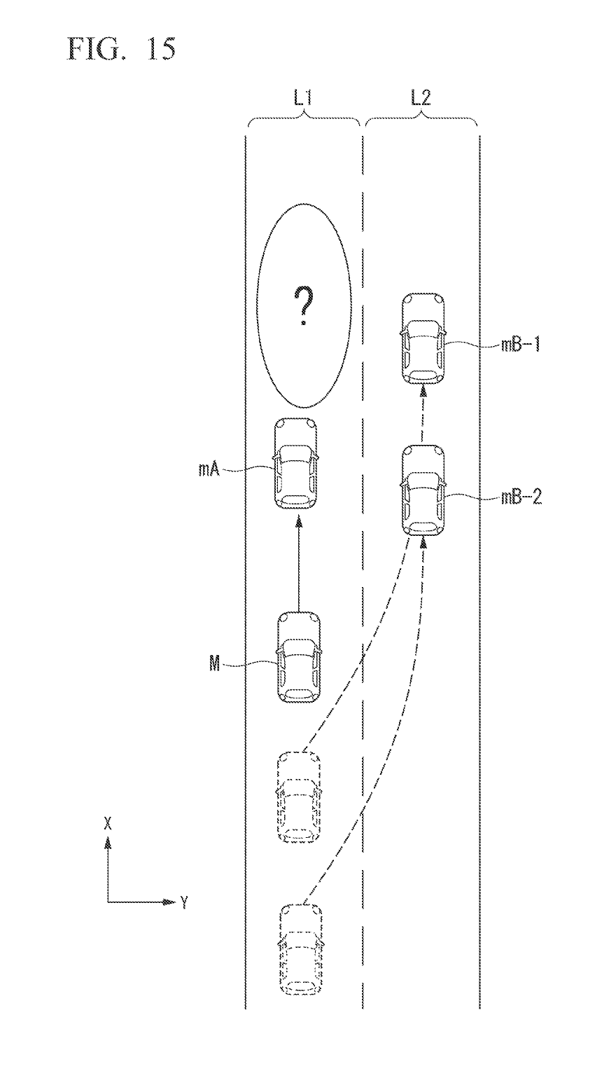

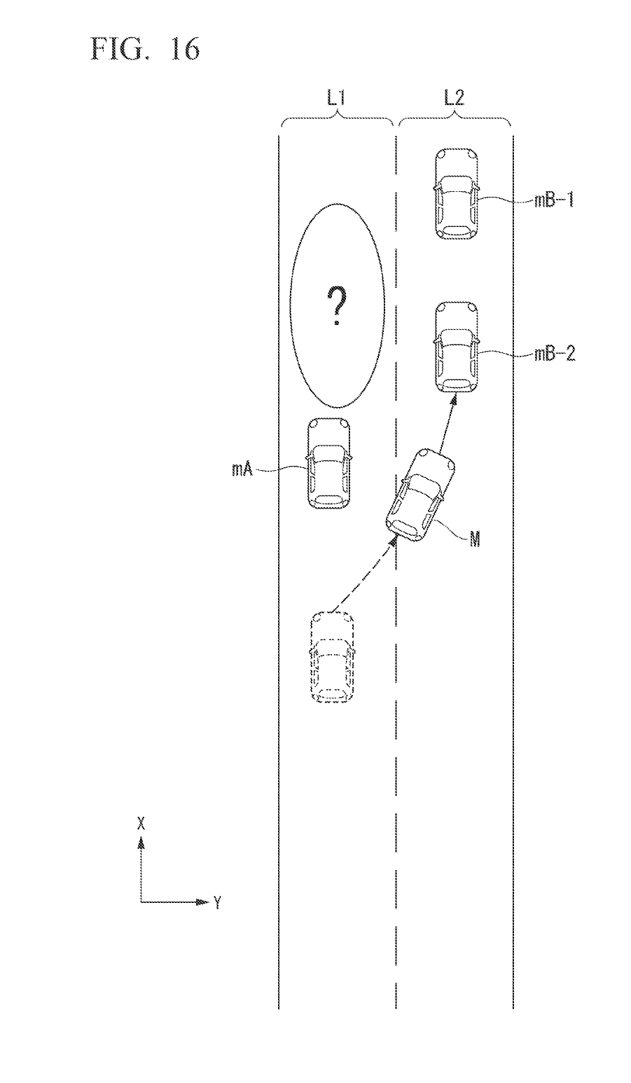

FIGS. 14 to 16 are diagrams showing an example of a scene in which there are a plurality of following vehicles. In the scene exemplified in FIG. 14, a recognizer 130 recognizes a first following vehicle mB-1 and a second following vehicle mB-2. In this case, the overtaking determiner 148 determines whether or not the first following vehicle mB-1 and the second following vehicle mB-2 have made a lane change from a host vehicle lane L1 to an adjacent lane L2 and have overtaken the host vehicle M. In the scene exemplified in FIG. 15, both the first following vehicle mB-1 and the second following vehicle mB-2 are overtaking the host vehicle M in the adjacent lane L2. In this case, the action plan generator 140 and the second controller 160 cause the host vehicle M to make a lane change to the adjacent lane L2 and overtake the preceding vehicle mA. When both of the first following vehicle mB-1 and the second following vehicle mB-2 have not overtaken the host vehicle M yet or when at least the second following vehicle mB-2 further behind the host vehicle M has not overtaken the host vehicle M, the action plan generator 140 and the second controller 160 cause the host vehicle M to wait in the host vehicle lane L1 until it is determined that the second following vehicle mB-2 has overtaken the host vehicle M. Thereby, it is possible to add a result of determining whether or not the plurality of following vehicles mB have overtaken the preceding vehicle mA as a determination index. As a result, it is possible to more accurately determine whether or not the host vehicle M is required to overtake the preceding vehicle.

According to the second embodiment described above, because the overtaking determiner 148 determines whether or not a plurality of following vehicles have made the lane change to the adjacent lane and have overtaken the host vehicle M when the recognizer 130 has recognized the plurality of following vehicles and the action plan generator 140 and the second controller 160 cause the host vehicle M to wait in the host vehicle lane without causing the host vehicle M to make the lane change to the adjacent lane until it is determined that the plurality of following vehicles have overtaken the host vehicle M by the overtaking determiner 148 and cause the host vehicle M to make the lane change to the adjacent lane and overtake the preceding vehicle when the overtaking determiner 148 determines that the plurality of following vehicles have overtaken the host vehicle M, it is possible to determine whether or not to cause the host vehicle M to overtake the preceding vehicle in consideration of a result of determining overtaking of the plurality of following vehicles. As a result, it is possible to more appropriately overtake a preceding vehicle in accordance with a surrounding traffic situation.

### [Hardware Configuration]

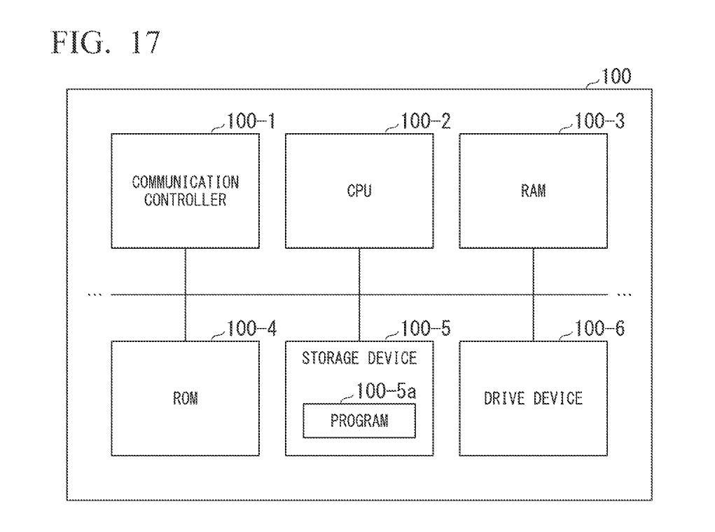

FIG. 17 is a diagram showing an example of a hardware configuration of the automated driving control device 100 of the embodiment. As shown, the automated driving control device 100 has a configuration in which a communication controller 100-1, a CPU 100-2, a RAM 100-3 used as a working memory, a ROM 100-4 storing a boot program and the like, a storage device 100-5 such as a flash memory or an HDD, a drive device 100-6, and the like are mutually connected by an internal bus or a dedicated communication line. The communication controller 100-1 communicates with other components than the automated driving control device 100. A program 100-5a executed by the CPU 100-2 is stored in the storage device 100-5. This program is loaded to the RAM 100-3 by a direct memory access (DMA) controller (not shown) or the like and executed by the CPU 100-2. Thereby, one or both of the first controller 120 and the second controller 160 are implemented.

The above-described embodiment can be represented as follows.

A vehicle control device including:

a storage configured to store a program; and

a processor,

wherein the processor executes the program to:

recognize a situation in the vicinity of a host vehicle;

determine whether or not speed of a preceding vehicle that is another vehicle present in front of the host vehicle in a host vehicle lane where the host vehicle is present is less than prescribed speed, the preceding vehicle being a recognized vehicle;

determine whether or not a following vehicle present behind the host vehicle in the host vehicle lane has overtaken the host vehicle when it is determined that the speed of the preceding vehicle is less than the prescribed speed, the following vehicle being a recognized vehicle; and

control speed and steering of the host vehicle and cause the host vehicle to overtake the preceding vehicle when it is determined that the following vehicle has overtaken the host vehicle.

While preferred embodiments of the invention have been described and exemplified above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer configured to recognize a situation in the vicinity of a host vehicle;
a first determiner configured to determine whether or not speed of a preceding vehicle present in front of the host vehicle in a host vehicle lane where the host vehicle is present is less than prescribed speed, the preceding vehicle being a vehicle recognized by the recognizer;
a second determiner configured to determine whether or not a following vehicle present behind the host vehicle in the host vehicle lane has overtaken the host vehicle when the first determiner determines that the speed of the preceding vehicle is less than the prescribed speed, the following vehicle being a vehicle recognized by the recognizer; and
a driving controller configured to control speed and steering of the host vehicle and cause the host vehicle to overtake the preceding vehicle when the second determiner determines that the following vehicle has overtaken the host vehicle.

2. The vehicle control device according to claim 1,
wherein the driving controller causes the host vehicle to overtake the preceding vehicle by causing the host vehicle to make a lane change to an adjacent lane adjacent to the host vehicle lane, and
wherein the driving controller causes the host vehicle to follow the following vehicle by further controlling at least speed of the host vehicle when the host vehicle is made to make a lane change to the adjacent lane.

3. The vehicle control device according to claim 1,
wherein the second determiner determines whether or not a plurality of following vehicles have made a lane change to an adjacent lane adjacent to the host vehicle lane to overtake the host vehicle when the recognizer has recognized the plurality of following vehicles, and
wherein the driving controller controls speed and steering of the host vehicle to cause the host vehicle to overtake the preceding vehicle when the second determiner determines that the plurality of following vehicles have overtaken the host vehicle.

4. The vehicle control device according to claim 3,
wherein the driving controller causes the host vehicle to wait in the host vehicle lane until the second determiner determines that the plurality of following vehicles have overtaken the host vehicle.

5. The vehicle control device according to claim 1,
wherein the second determiner further determines whether or not there is a road sign indicating the prohibition of parking or stopping alongside the host vehicle lane, and
wherein the driving controller prevents the host vehicle from overtaking the preceding vehicle when the second determiner determines that the road sign is present alongside the host vehicle lane.

6. The vehicle control device according to claim 1,
wherein the second determiner further determines whether or not there is a prescribed point at which overtaking within a prescribed distance in front of the host vehicle is prohibited, and
wherein the driving controller prevents the host vehicle from overtaking the preceding vehicle when the second determiner determines that the prescribed point is present within the prescribed distance in front of the host vehicle.

7. The vehicle control device according to claim 1,
wherein the recognizer recognizes a light color of a traffic light in front of the host vehicle,
wherein the second determiner further determines whether or not the light color of the traffic light recognized by the recognizer is a prescribed color indicating passage prohibition, and
wherein the driving controller prevents the host vehicle from overtaking the preceding vehicle when the second determiner determines that the light color of the traffic light is the prescribed color.

8. The vehicle control device according to claim 1,
wherein the second determiner further determines whether or not the preceding vehicle is a prescribed type of vehicle, and
wherein, when the second determiner determines that the preceding vehicle is the prescribed type of vehicle, the driving controller controls speed and steering of the host vehicle and causes the host vehicle to overtake the preceding vehicle.

9. The vehicle control device according to claim 1,
wherein the first determiner further determines whether or not speed of the following vehicle overtaking the host vehicle in an adjacent lane adjacent to the host vehicle lane is less than prescribed speed, and
wherein, when the second determiner determines that the following vehicle has overtaken the host vehicle and the first determiner determines that the speed of the following vehicle overtaking the host vehicle in the adjacent lane adjacent to the host vehicle lane is less than or equal to the prescribed speed, the driving controller prevents the host vehicle from overtaking the preceding vehicle.

10. The vehicle control device according to claim 1,
wherein, when the recognizer does not recognize the following vehicle until a prescribed time has elapsed after the first determiner determines that the speed of the preceding vehicle is less than the prescribed speed or when the second determiner does not determine that the following vehicle has overtaken the host vehicle, the driving controller controls speed and steering of the host vehicle and causes the host vehicle to overtake the preceding vehicle.

11. A vehicle control method comprising:
recognizing, by an in-vehicle computer, a situation in the vicinity of a host vehicle;
determining, by the in-vehicle computer, whether or not speed of a preceding vehicle present in front of the host vehicle in a host vehicle lane where the host vehicle is present is less than prescribed speed, the preceding vehicle being a recognized vehicle;
determining, by the in-vehicle computer, whether or not a following vehicle present behind the host vehicle in the host vehicle lane has overtaken the host vehicle when it is determined that the speed of the preceding vehicle is less than the prescribed speed, the following vehicle being a recognized vehicle; and
controlling, by the in-vehicle computer, speed and steering of the host vehicle and causing the host vehicle to overtake the preceding vehicle when it is determined that the following vehicle has overtaken the host vehicle.

12. A computer-readable non-transitory storage medium storing a program for causing an in-vehicle computer to execute:
a process of recognizing a situation in the vicinity of a host vehicle;
a process of determining whether or not speed of a preceding vehicle present in front of the host vehicle in a host vehicle lane where the host vehicle is present is less than prescribed speed, the preceding vehicle being a recognized vehicle;
a process of determining whether or not a following vehicle present behind the host vehicle in the host vehicle lane has overtaken the host vehicle when it is determined that the speed of the preceding vehicle is less than the prescribed speed, the following vehicle being a recognized vehicle; and
a process of controlling speed and steering of the host vehicle and causing the host vehicle to overtake the preceding vehicle when it is determined that the following vehicle has overtaken the host vehicle.
